(19) United States
(12) Patent Application Publication
(10) Pub. No.: US 2008/0198975 A1
(43) Pub. Date: Aug. 21, 2008

(54) SYSTEM AND APPARATUS FOR RESPONDING TO CALLBACK MESSAGES

(75) Inventors: PAUL WHITEHEAD, Boerne, TX (US); GREGORY JONES, Dallas, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/677,543

(22) Filed: Feb. 21, 2007

(51) Int. Cl. H04M 1/64

(52) U.S. Cl. 379/67.1

(57) ABSTRACT

A system and apparatus for responding to callback message is disclosed. An apparatus that incorporates teachings of the present disclosure may include, for example, a message processing system having a controller element that compares presence information associated with a calling party and a callback identifier supplied by the calling party directed to a called party. Additional embodiments are disclosed.

### FIELD OF THE DISCLOSURE

The present disclosure relates generally to communication systems, and more specifically to a system and apparatus for responding to callback messages.

### BACKGROUND

Typically when a calling party leaves a callback message such as voicemail, the called party must listen to most of the message to retrieve a callback number or other identifier. Some prior art systems propose attaching a caller ID to the voicemail message so that the called party can select between the caller ID or the callback number retrieved from the voicemail message using voice recognition techniques to respond to the call. Although these techniques can be useful, it is not always the case that the calling party will be available at a communication device associated with the caller ID or the callback number.

This is especially true when the called party retrieves the voicemail message at a much later time than when it was entered (e.g., hours or next day). Under these circumstances, the calling party may be using a communication device which is not associated with the caller ID or the callback number. An example of this may be where the calling party leaves the voicemail message using a friend's phone with a callback number corresponding to his/her cell phone. After several hours, the calling party is now located at his/her home with the cell phone turned off and accepting calls only through a home phone. Selecting the option to respond to the call via caller ID (friend's home) or the callback number left by the calling party (calling party's cell phone) will not locate the calling party. This can be a frustrating and an undesirable experience for the called party.

A need therefore arises for a system and apparatus for responding to callback messages.

### BRIEF DESCRIPTION OF THE DRAWINGS

FIG. 1 depicts an exemplary embodiment of a communication system;

FIG. 2 depicts an exemplary block diagram of one of several embodiments for a terminal device operating in the communication system;

FIG. 3 depicts an exemplary method operating in portions of the communication system; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and apparatus for responding to voicemail messages.

In a first embodiment of the present disclosure, a computer-readable storage medium can have computer instructions for recording a callback identification (ID) supplied by a calling party directed to a called party, and comparing the callback ID to presence information associated with the calling party.

In a second embodiment of the present disclosure, a message processing system can have a controller element that compares presence information associated with a calling party and a callback identifier supplied by the calling party directed to a called party.

In a third embodiment of the present disclosure, a terminal device can have a controller element that receives a callback instruction from a system that compares a callback ID supplied by a calling party and presence information associated with the calling party.

In a fourth embodiment of the present disclosure, a presence system can have a controller element that supplies to a message processing system presence information associated with one or more communication devices of a calling party for comparison with a callback ID supplied by the calling party to said message processing system.

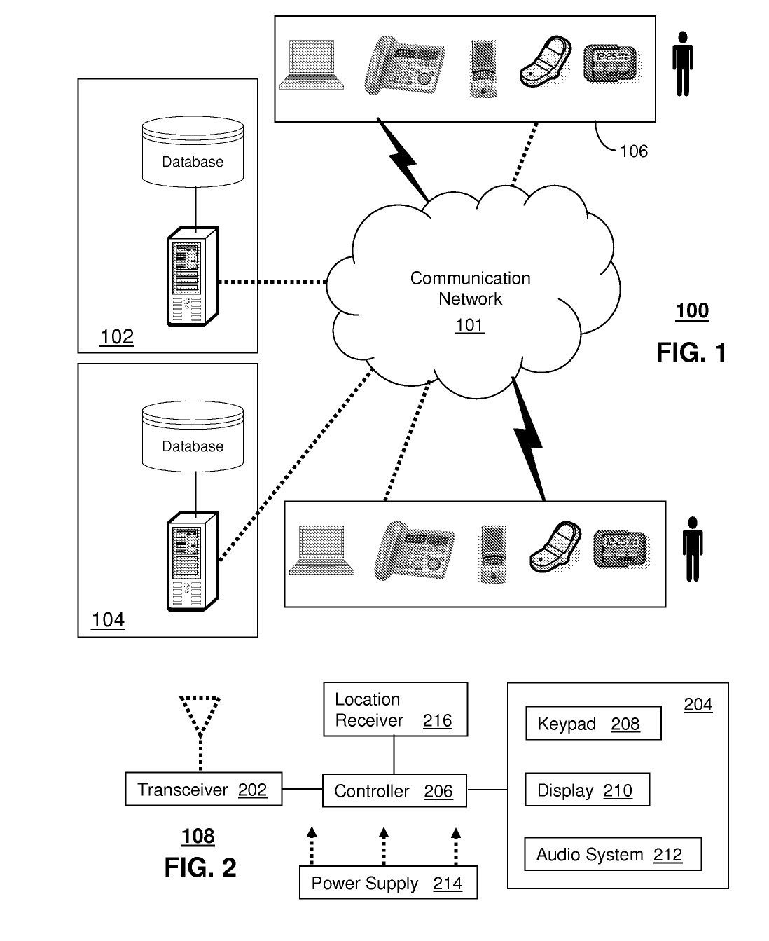

FIG. 1 depicts an exemplary embodiment of a communication system 100. The communication system 100 can comprise a presence system 102, a message processing system 104, and one or more terminal devices 106 coupled to a communication network 101. The foregoing components 102-106 of the communication system 100 can utilize common computing and communications technologies to support circuit-switched and/or packet-switched communications.

The presence system 102 can be utilized to track the whereabouts and status of a party communicating with one or more of the terminal devices 106 in the communications network 101. Presence information derived from a presence system 102 can include a location of a party utilizing a terminal device 106, the type of device used by the party (e.g., cell phone, PDA, home phone, home computer, etc.), and/or a status of the party (e.g., busy, offline, actively on a call, actively engaged in instant messaging, etc.). The presence system 102 performs said operations for parties who are subscribed to services of the presence system 102.

The message processing system 104 can be utilized to record callback messages when a calling party is unable to communicate with a called party. The callback message supplied by a calling party can represent a caller ID retrieved from a call initiated by the calling party over the communication network 101 utilizing common means, and/or a voicemail message supplied thereby. The message processing system 104 can include technology such as found in an interactive voice response system (IVR) for interacting with the calling and called parties utilizing voice and keyed input signals (e.g., DTMF tones), and for processing a callback message supplied by the calling party according to a particular call flow design. The message processing system 104 can support subscribers who are interested in storing callback messages when a calling party is unable to reach the subscriber. The presence and message processing systems 102-104 can be provisioned to interact cooperatively to enhance processing of callback messages.

The communication network 101 comprises a number of common network elements interconnected by wired or wireless interfaces that support packet-switched and/or circuit-switched technologies. The communications network 101 can thus offer terminal devices 106 Internet and/or traditional voice services such as, for example, POTS (Plain Old Telephone Service), VoIP (Voice over Internet communications, IPTV (Internet Protocol Television), broadband communications, cellular telephony, as well as other known or next generation access technologies.

The terminal devices 106 can represent any number of embodiments including without limitation a laptop or desktop computer, a POTS phone, a personal digital assistance (PDA), a cellular phone, or paging device, just to name a few. Some or all of these devices can interface to the communication network 101 with a wired or wireless interface. For example, the laptop can be interconnected to the communications network 101 by a wired Ethernet port to a DSL (Digital Service Line) interface in a residence or enterprise, or by a WiFi or WiMAX wireless connection. The POTS phone can utilize cordless 2.4 GHz or 5.8 GHz technology for short-range roaming, and interface to the communications network 101 using POTS or VoIP communications. The PDA and cellular phone can support common wireless access technologies for interfacing to the communications network 101.

Additionally, functions of the aforementioned terminal devices 106 in FIG. 1 can be combined so as to create a multifunctional or multimode communication device. For example, VoIP, paging, email, calendaring, WiFi, and cellular communication functionality can be integrated into the PDA.

FIG. 2 depicts an exemplary embodiment of the terminal device 106. A terminal device 106 can comprise a wired and/or wireless transceiver 202, a user interface (UI) 204, a power supply 214, a location receiver 216, and a controller 206 for managing operations thereof. In an embodiment where the terminal device 106 operates in a landline environment, the transceiver 202 utilizes common wireline access technology to support POTS or VoIP services.

In a wireless communications setting, the transceiver 202 can utilize common technologies to support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to any number of communication protocols that can be dynamically downloaded over-the-air to the terminal device. It should be noted also that next generation wireless access technologies can be applied to the present disclosure.

The UI 204 can include a keypad 208 with depressible or touch sensitive navigation disk and keys for manipulating operations of the terminal device 106. The UI 204 can further include a display 210 such as monochrome or color LCD (Liquid Crystal Display) for conveying images to the end user of the terminal device, and an audio system 212 that utilizes common audio technology for conveying and intercepting audible signals of the end user.

The power supply 214 can utilize common power management technologies such as replaceable batteries, supply regulation technologies, and charging system technologies for supplying energy to the components of the terminal device and to facilitate portable applications. In stationary applications, the power supply 214 can be modified so as to extract energy from a common wall outlet and thereby supply DC power to the components of the terminal device 106.

The location receiver 216 can utilize common technology such as a common GPS (Global Positioning System) receiver that can intercept satellite signals and therefrom determine a location fix of the terminal device 106.

The controller 206 can utilize computing technologies such as a microprocessor and/or digital signal processor (DSP) with associated storage memory such a Flash, ROM, RAM, SRAM, DRAM or other like technologies for controlling operations of the aforementioned components of the terminal device.

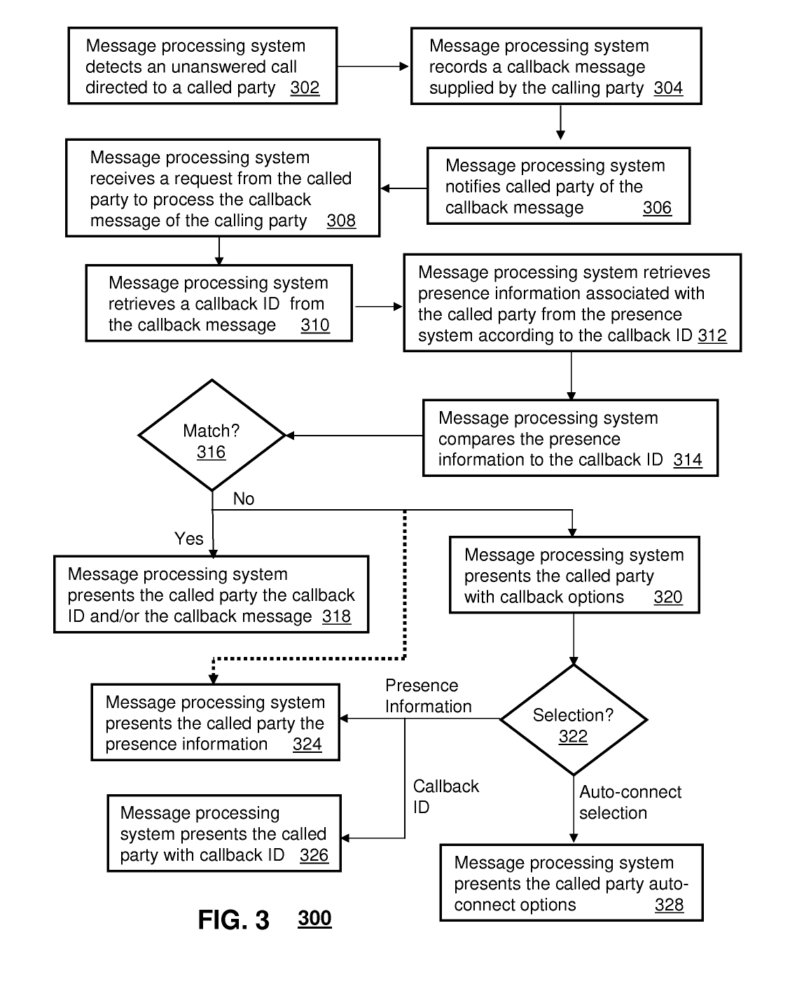

FIG. 3 depicts an exemplary method 300 operating in portions of the communication system 100. Method 300 begins with step 302 where the message processing system 104 detects an unanswered call from a terminal device 106 of a calling party and directed to a terminal device of a called party over the communication network 101. In this step, the message processing system 104 can present the calling party options to supply a callback message such as, for example, a caller ID retrieved from the communication network 101 (e.g., Automatic Number Identification also known as ANI) or keyed in by the calling party by way of the terminal device, and/or a voicemail message. The interactions with the calling party as noted earlier can be based on IVR technology operating in the message processing system 104 that supports a call flow specific for processing callback messages according to feedback supplied by the calling party (e.g., DTMF tones, voice responses, or other forms of electronic response entry).

In step 304, the message processing system 104 records in its memory a callback message supplied by the calling party according to selections made by the calling party. The message processing system 104 can in step 306 notify the called party that a callback message has been recorded. The notification can be conveyed by any communication means to any terminal device 106 of the called party (e.g., email, wireless text message, notice indicator on a POTS or cellular phone, etc.). In step 308, the message processing system 104 can receive a request from the called party to process the callback message of the calling party. As before, the interaction with the called party can occur according to an IVR call-flow. The message processing system 104 in step 310 can respond to said request by retrieving a callback ID from the callback message. In a situation where the callback message represents a voicemail message, the message processing system 104 can utilize common voice recognition techniques to detect a voice segment in the voicemail message that includes the callback ID.

A voice segment corresponding to the callback ID can be detected when a portion of the voicemail message provides an indication the calling party has left a callback ID (e.g., a telephone number, an email address, a pager number, an instant messaging address, an ID conforming to a telephone number mapping (ENUM) protocol, or other forms of an identifier that can be utilized for communicating with the calling party). Once the appropriate voice segment has been retrieved from the voicemail message, the message processing system 104 can utilize common voice-to-speech synthesis technology to translate the voice segment to a text message representative of the callback ID. In a situation where the callback message includes a caller ID, then the message processing system 104 can retrieve said caller ID from its memory to generate the callback ID.

Once the callback ID has been retrieved, the message processing system 104 in step 312 retrieves presence information associated with the called party from the presence system 102 according to said callback ID. The presence system 102 utilizes the callback ID supplied by the message processing system 104 as a means to identify the calling party and thereby retrieves active presence information monitored by the presence system utilizing common presence sensing techniques (e.g., GPS, activity monitoring at each of the terminal devices 106 of the calling party, status information proactively supplied by the calling party, and so on).

In step 314, the message processing system 104 compares the presence information to the callback ID. If a match is detected in step 316, the message processing system 104 presents in step 318 the called party the callback ID and/or the callback message as selected by the called party using the IVR. The presentation of the callback ID and/or the callback message can be a voice or text message transmitted by the communication network 101 to the terminal device 106 of the called party. The message processing system 104 can also perform an auto-connect function according to the callback ID in response to a request by the called party utilizing the IVR functions of the message processing system 104.

If on the other hand, a mismatch is detected in step 316 between the presence information and the callback ID indicative of the calling party transferring to a terminal device 106 different from the one associated with the callback ID, the message processing system 104 can proceed to step 320 where it presents the called party with callback options. It should be noted that a mismatch in step 316 can result from a prolonged time between the delivery of the callback message in step 304 and a time in which the called party decides to retrieve said message. For long periods of time, the calling party is more likely to transfer between terminal devices 106. Other reasons for the calling party transferring between terminal devices 106 can also apply.

The callback options presented in step 322 can include a presentation of the presence information in step 324 which is the more up-to-date means to reach the calling party, a presentation of the callback ID in step 326 (notwithstanding its expired use for contacting the calling party), and/or an auto-connection option applied to either selection in step 328. These options can be presented by the IVR of the message processing system 104 utilizing a voice-enabled and touch-key controllable call flow detectable in step 322, or by transmitting text messages to the terminal device 106 of the called party which can be responded to utilizing the UI 204 of the terminal device and detectable in step 322 by the message processing system. In the case of an auto-connect selection, the message processing system 104 automatically establishes a communication between the terminal device 106 of the called party and a terminal device of the calling party according to either the presence information or the callback ID selected by the called party in step 322.

Referring back to step 316, if a mismatch between the presence information and the callback ID is detected, the message processing system 104 can alternatively present the terminal device 106 of the called party the most up-to-date communication information for the calling party foregoing the callback options of step 320. Step 324 can also be supplemented with an auto-connect feature as described in step 328.

Upon reviewing the aforementioned embodiments, it would be evident to an artisan with ordinary skill in the art that said embodiments can be modified, reduced, or enhanced without departing from the scope and spirit of the claims described below. Accordingly, the reader is directed to the claims section for a fuller understanding of the breadth and scope of the present disclosure.

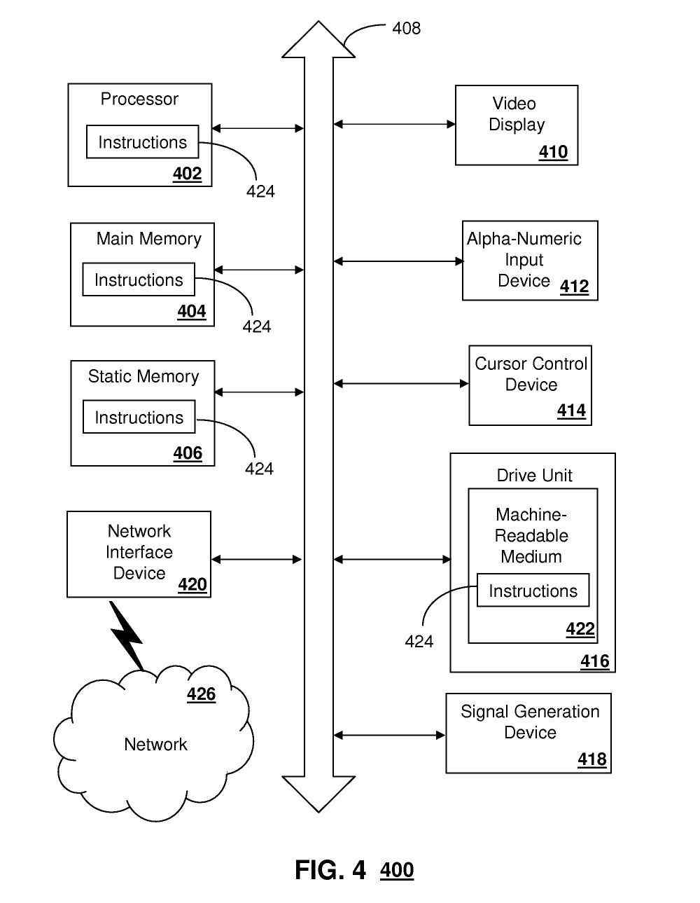

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
recording a callback identification (ID) supplied by a calling party directed to a called party; and
comparing the callback ID to presence information associated with the calling party.

2. The storage medium of claim 1, comprising computer instructions for retrieving the presence information associated with the calling party according to the callback ID.

3. The storage medium of claim 1, comprising computer instructions for presenting the called party the presence information in response to detecting a mismatch between the presence information and the callback ID.

4. The storage medium of claim 1, comprising computer instructions for presenting the called party the callback ID in response to detecting a match between the presence information and the callback ID.

5. The storage medium of claim 1, comprising computer instructions for retrieving the callback ID from a call initiated by the calling party that is directed to the called party.

6. The storage medium of claim 1, comprising computer instructions for:
recording a callback message supplied by the calling party; and
retrieving the callback ID from the callback message.

7. The storage medium of claim 6, comprising computer instructions for:
detecting the callback ID in the callback message by voice recognition;
retrieving a voice segment associated with the callback ID from the callback message;
translating the voice segment into a text message; and
comparing said text message with the presence information.

8. The storage medium of claim 1, comprising computer instructions for:
detecting a mismatch between the callback ID and the presence information; and
presenting the called party one or more callback options.

9. The storage medium of claim 8, wherein the one or more callback options comprise at least one among presentation of the presence information, presentation of the callback ID, and an auto-connection option for one among the presence information and the callback ID.

10. The storage medium of claim 1, wherein the presence information comprises an identifier corresponding to a communication device actively in use by the calling party at a time when the presence information is retrieved, and wherein the callback ID comprises one among a telephone number, an ID conforming to a telephone number mapping (ENUM) protocol, an email address, and an instant messaging address.

11. The storage medium of claim 3, comprising computer instructions for presenting at a terminal device of the called party the presence information, wherein said presentation comprises one among a voice message and a text message transmitted to the terminal device.

12. The storage medium of claim 4, comprising computer instructions for presenting at a terminal device of the called party the callback ID, wherein said presentation comprises one among a voice message and a text message transmitted to the terminal device.

13. A message processing system, comprising a controller element that compares presence information associated with a calling party and a callback identifier supplied by the calling party directed to a called party.

14. The message processing system of claim 13, wherein the controller element retrieves the presence information associated with the calling party.

15. The message processing system of claim 13, wherein the controller element presents the called party one among the presence information in response to detecting a mismatch between the presence information and the callback ID, and the callback ID in response to detecting a match between the presence information and the callback ID.

16. The message processing system of claim 15, wherein said presentation comprises one among a voice message and a text message transmitted to a terminal device of the called party.

17. The message processing system of claim 13, wherein the controller element retrieves the callback ID from one among a call initiated by the calling party that is directed to the called party and a voicemail message supplied by the calling party.

18. The message processing system of claim 13, wherein the controller element:
detects a mismatch between the callback ID and the presence information, and
presents the called party one or more callback options comprising at least one among the presence information, the callback ID, and an auto-connection of one among the presence information and the callback ID.

19. The message processing system of claim 18, wherein the controller element receives from a terminal device of the called party a request for the auto-connection for a select one of the presence information and the callback ID and initiates a communication transaction for said terminal device responsive to said selection.

20. A terminal device, comprising a controller element that receives a callback instruction from a system that compares a callback ID supplied by a calling party and presence information associated with the calling party.

21. A presence system, comprising a controller element that supplies to a message processing system presence information associated with one or more communication devices of a calling party for comparison with a callback ID supplied by the calling party to said message processing system.
